(19) United States
(12) Patent Application Publication
(10) Pub. No.: US 2026/0109826 A1
(43) Pub. Date: Apr. 23, 2026

(54) FOAM BASED ON POLYLYSINE

(71) Applicant: BASF SE, Ludwigshafen am Rhein (DE)

(72) Inventors: Alexander KOENIG, Ludwigshafen am Rhein (DE); Johannes AHRENS, Ludwigshafen am Rhein (DE); Gereon Antonius SOMMER, Ludwigshafen am Rhein (DE); Frank REUTER, Ludwigshafen am Rhein (DE); David TUERP, Ludwigshafen am Rhein (DE)

(21) Appl. No.: 19/117,708

(22) PCT Filed: Sep. 28, 2023
(86) PCT No.: PCT/EP2023/076922

§ 371 Date: Apr. 2, 2025

(30) Foreign Application Priority Data
Oct. 5, 2022 (EP) 22199805.7

(51) Int. Cl. C08J 9/00; C08J 9/06; C08J 9/14

(52) U.S. Cl. CPC C08J 9/0061; C08J 9/06; C08J 9/141; C08J 2201/026; C08J 2203/14

(57) ABSTRACT

The present invention relates to a process for producing a foam, which comprises foaming a mixture, comprising one or more poly (amino acid) (A), one or more components (B) capable of reacting with said poly (amino acid) (A), wherein component (B) is selected from reducing sugars, 1,3-dihydroxyacetone, glycolaldehyde, glyceraldehyde or any mixture thereof and one or more blowing agents (F) and the foam obtainable by this process.

The present invention relates to a process for producing a foam, which comprises foaming a mixture, comprising one or more poly (amino acid) (A), one or more components (B) capable of reacting with said poly (amino acid) (A) and one or more blowing agents (F), wherein component (B) is selected from reducing sugars, 1,3-dihydroxyacetone, glycolaldehyde, glyceraldehyde or any mixture thereof and the foam obtainable by this method.

### RELEVANT PRIOR ART

Reactive, non-thermoplastic (thermoset) polymer foams are used for many applications. In the case of flexible non-thermoplastic polymer foams the products are applied in acoustic absorption, cushioning, cleaning, packaging and many more.

For receiving these foams three technologies are known. Flexible polyurethane foams can be foamed by the use of water. The water reacts exothermally with isocyanate group of the respective isocyanate (e. g. TDI or MDI) to the bisubstituted urea and CO2. The CO2 acts as intrinsic blowing agent in the foam formation. The final foams show a high flexibility and good acoustic absorption. Sometimes, the blowing reaction is supported by a physical blowing agent, e. g. pentane. But the use of isocyanates causes high safety efforts for a safe transport, storage, processing, and disposal. Flexible foams based on polyurethanes are described in many sources, e. g. DE10226414A1.

Another example of receiving flexible, non-thermoplastic foams are melamine resin foams described in DE09929A1. The foams are generated by a melamine-formaldehyde-condensate, surfactants, salts, curing agent and a physical blowing agent, e. g. pentane or hydrofluoroolefins. Due to the low exothermicity the foaming process has to be supported by hot air and/or microwave and/or water steam. The resulting foams are lightweight, show a very good sound absorption behavior, a good thermal insulation as well as a good cleaning behavior. But the application of these foams is limited due to the potential of formaldehyde emissions during production and in the applications.

Another example of receiving a flexible foam is described in DE2950289A1. These foams are based on urea-formaldehyde condensates deliver flexible foams with densities of 8-40 kg/m³ by an oven method and pentane as blowing agent. Also here, the applications are limited due to the potential of formaldehyde emissions during production and in the applications.

WO 2016/009062 and WO 2011/138458 disclose a binder comprising the reaction product of a carbohydrate reactant and polyamine useful for consolidating loosely assembled matter, such as fibers. Foams using the binder are not disclosed.

WO 2022/136613 discloses a binder composition comprising polylysine having a total weight average molecular weight Mw of at least 800 g/mol as component A and 1,3-dihydroxyacetone, glycolaldehyde, glyceraldehyde or mixtures thereof as component B and use for manufacturing lignocellulosic composite articles. Foams using the binder composition are not disclosed.

WO 2022/136614 relates to a binder composition comprising polyamines and hydroxyacetone for composite articles. Foams using the binder composition are not disclosed.

US 2011/0257284 A1 describes a process for producing flame-retardant polyurethane foams. using hyperbranched, nitrogen-containing polymers, in particular hyperbranched polylysines, hyperbranched polyisocyanurates, and hyperbranched polyesteramides for providing flame retardancy to polyurethane foams.

### SUMMARY OF THE INVENTION

The present invention was made in view of the prior art described above, and the object of the present invention is to provide a formaldehyde- and isocyanate-free, flexible foam with good mechanical properties, which can be obtained from bio- and water-based raw materials.

### Technical Problem Solved

This object was solved by a foam and a process for producing the foam, which comprises foaming a mixture, comprising one or more poly (amino acid) (A), one or more components (B) capable of reacting with said poly (amino acid) (A) and one or more blowing agents (F), wherein component (B) is selected from reducing sugars, 1,3-dihydroxyacetone, glycolaldehyde, glyceraldehyde or any mixture thereof.

Foaming of the mixture can be achieved by using an external heat source, such as hot molds or hot air and/or the use of microwave.

Preferably the foam is not a polyurethane foam. Preferably the foaming mixture does not contain isocyanates and/or polyols. Preferably the foaming mixture comprises more than 50 wt.-%, more preferably more than 70 wt.-% or the poly (amino acid) (A) based on the solids of the sum of the reactive components (A) and (B).

Preferably the process comprises foaming a mixture, which comprises
10 to 60 wt.-% of one or more poly (amino acid) (A)
3 to 30 wt.-% of one or more components (B) capable of reacting with said poly (amino acid) (A)
0.5 to 5 wt.-% of one or more salts of an inorganic acid or organic carboxylic acid (C),
3 to 10 wt.-% of one or more surfactants (D),
to 60 wt.-% of water (E),
1 to 20 wt.-% of one or more physical blowing agents (F),
0 to 82.5 wt.-% of one or more additional additives (G),
wherein the sum of the weight percentages of said components A) to G) is 100 wt.-%.

More preferably the process comprises a foaming mixture which essentially consist of the components A) to (F) in the above-mentioned amounts.

Most preferably the process comprises foaming a mixture, which consist of
20 to 60 wt.-% of one or more poly (amino acid) (A)
3 to 30 wt.-% of one or more components (B) capable of reacting with said poly (amino acid) (A)
0.5 to 5 wt.-% of one or more salts of an inorganic acid or organic carboxylic acid (C),
3 to 10 wt.-% of one or more surfactants (D),
10 to 60 wt.-% of water (E),
1 to 20 wt.-% of one or more physical blowing agents (F),
wherein the sum of the weight percentages of said components A) to F) is 100 wt.-%.

### Component (A)

As component (A) poly (amino acid) s e.g. synthetic poly (amino acid) s, natural poly (amino acid) s, polypeptides, proteins or mixtures thereof are used. Poly (amino acid) s are produced by polymerization of amino acids. Poly (amino acid) s can be obtained by chemical synthesis or by biosynthesis in living organisms. In particular, proteins may be obtained by biosynthesis in living organisms. Polypeptides may be obtained by hydrolysis of proteins.

According to this invention the term poly (amino acid) s may also include poly (amino acid) derivatives, which may be obtained by modification of the poly (amino acid) after polymer synthesis.

Preferred amino acids which are used for the polymerization reaction are diamino acids comprising two amine groups (—NH2) and at least one carboxyl (—COOH) functional group. Such diamino acids may be ornithine, diaminopimelic acid, 2,3-diaminopropionic acid, 2,4-diaminobutyric acid, and/or lysine, preferably lysine, more preferably L-lysine. Although they are sometimes named as diamino acids, according to this invention asparagine and glutamine are not included in the group of diamino acids, since the second functional group is an amide (CO—NH2) and not an amine (—NH2).

Preferably polylysine is used as poly (amino acid). Polylysine may be produced by the polymerization of lysine. Lysine itself may be produced by the fermentation of corn starch, sugar or other carbon hydrates in presence of suited bacteria. The production of polylysine is generally known and may be performed as e.g., described in WO 2016/062578 or from lysine salts as described in WO 2007/060119. A preferred process for producing polylysine is described in WO 2022/136613.

Preferably, component (A) comprise(s) at least one polylysine or consist(s) of one or more polylysine(s), which is (are) a polymerization product of monomer lysine, preferably L-lysine, and optionally other monomers selected from the group consisting of
a) amino acids, preferably comprising at least two amino groups,
b) amines comprising at least two amino groups, wherein the amines are no amino acids, and
c) di and/or tricarboxylic acids, which are preferably no amino acids,
wherein at least 50 wt.-%, preferably at least 75 wt.-%, most preferably 100 wt.-% lysine, is used as monomer for the polymerization reaction based on total amount of monomers.

Weight-average molecular weight Mw of the poly (amino acid) (A) has an influence on mechanical properties of the foam. Preferably the poly (amino acid) (A) has a weight-average molecular weight Mw in the range from 500 to 20,000 g/mol, more preferably in the range from 800 to 3,500 g/mol. Weight-average molecular weights are determined by size exclusion chromatography (SEC) on hydroxylated polymethacrylate with 0.1% (w/w) trifluoroacetate as solvent and 0.1 M NaCl in distilled water as eluent and calibration with poly (2-vinylpyridine) standards. Most preferably polylysine in aqueous formulation with a molecular weight from 800 to 3,500 g/mol is used as component (A) for producing foams with a suitable Shore hardness and compression load.

### Component (B)

One or more components (B) capable of reacting with said poly (amino acid) (A) selected from reducing sugars, 1,3-dihydroxyacetone, glycolaldehyde, glyceraldehyde or any mixture thereof are used in the foaming mixture. Preferably hydroxy acetone or 1,3-dihydroxyacetone is used as component (B).

Preferably the weight ratio of poly (amino acid) (A) to component (B) is in the range from 2:1 to 5:1.

Poly(amino acid) and reducing sugars from natural sources can be used as raw materials to produce essentially bio-based foams.

It is assumed that component A and B undergoes Maillard reaction. In the first step the free amine group of a (poly) amino acid (component (A)) is added to the carbonyl group of a reducing sugar (ketose/aldose) (component (B)). The formed glycosylamine is unstable and undergoes a Heyns/Amadori rearrangement to the Heyns/Amadori compound (aldosamine/ketosamine) with loss of one water molecule.

In the case of the reaction of polylysine with (di) hydroxyacetone, a crosslinked thermoset light-brown solid material is formed.

### Component (C)

As component (C) one or more salts of an inorganic acid and/or one or more salts of an organic carboxylic acid added for stabilization of the foam. Particularly suitable are one or more salts, particularly sodium—and/or potassium salts, of the oxygen or sulfur, as the formic acid, the acetic acid, and the citric acid. Also especially suitable are chlorides, bromides, nitrates, and dihydrogen phosphates, in particular in the form of the sodium- and/or potassium salts. Preferably in the form of salts of an inorganic acid and/or salts of an organic carboxylic acid are in particular a sodium—and potassium formates or more compounds selected from, -acetates, citrates-, -chlorides, -bromides, -sulfates, -sulfites, -nitrates and dihydrogen phosphates. Very particularly suitable salts of an inorganic acid and/or salts of an organic carboxylic acid are formates, citrates, and mixtures thereof.

Preferable halogen-free salts are used to obtain halogen-free foams.

### Component (D)

Component D) of the system comprises one or more surfactants used to form and stabilize the foam. Anionic, cationic, nonionic, or amphoteric surfactants are usable.

Suitable anionic surfactants are diphenylene oxide sulfonates, alkane- and alkylbenzenesulfonates, alkylnaphthalenesulfonates, olefinsulfonates, alkyl ether sulfonates, alkyl sulfates, alkyl ether sulfates, alpha-sulfofatty acid esters, acylaminoalkanesulfonates, acylisethionates, alkyl ether carboxylates, N-acylsarcosinates, alkyl and alkyl ether phosphates.

Useful nonionic surfactants include alkylphenol polyglycol ethers, fatty alcohol polyglycol ethers, fatty acid polyglycol ethers, fatty acid alkanolamides, EO-PO block copolymers, amine oxides, glyceryl fatty acid esters, sorbitan esters and alkylpolyglucosides. Useful cationic surfactants include alkyltriammonium salts, alkylbenzyldimethylammonium salts and alkylpyridinium salts.

Mixtures of anionic and nonionic surfactants are employed with particular preference.

Preferably a mixture of an anionic and a non-ionic surfactant is used as surfactant (D). More preferably a mixture of the sodium salt of a (C12-14) fatty alcohol ether sulfate, a (C12-C14)alkyl polyglycoside or mixture therefrom are used as surfactants (D).

Preferably the weight ratio of anionic surfactant to non-ionic surfactant is in the range from 50:50 to 90:10.

### Component (E)

Water is used as Component (E). Preferably components (A), (B) and (D) are used as aqueous solutions or dispersions. Further water may be added to achieve the above-described composition of the mixture and to adjust viscosity.

### Component (F)

In principle, the process of the present invention can use both physical and chemical blowing agents. “Physical” or “chemical” blowing agents are suitable (Encyclopedia of Polymer Science and Technology, Vol. I, 3rd ed., Additives, pages 203 to 218, 2003).

Useful physical blowing agents as component (F) include for example hydrocarbons, such as butane, n-, iso- or cyclo-pentane, hexane, halogenated, more particularly chlorinated and/or fluorinated, hydrocarbons, for example methylene chloride, chloroform, trichloroethane, chlorofluorocarbons, hydrochlorofluorocarbons (HCFCs), hydrofluorocarbons (HCFs) like methylnonafluorbutylether, ethylnonofluorbutylether, hydrofluoroolefins (HFOs) like hexafluorobutene, alcohols, for example methanol, ethanol, n-propanol or isopropanol, ethers, ketones and esters, for example methyl formate, ethyl formate, methyl acetate or ethyl acetate. Preferred physical blowing agents are those having a boiling point of between 0 and 80° C.

Useful chemical blowing agents include for example isocyanates mixed with water, releasing carbon dioxide as active blowing agent. It is further possible to use carbonates and bicarbonates mixed with acids, in which case carbon dioxide is again produced. Also suitable are azo compounds, for example azodicarbonamide.

Preferably the physical blowing agent (F) is a C4-C8-hydrocarbon, more preferably n-, iso- or cyclo-pentane, most preferably a mixture of n-pentane and isopentane 80:20.

Preferably 1 to 20 wt.-% of one or more physical blowing agents are used to obtain foams with densities in the range from 10 to 250 kg/m³.

### Component (G)

Flame-retardants, fillers may be used as further components (G). Preferably a flame retardant is used as additive (G).

Subject of the invention is also a process for producing a foam by preparing an aqueous solution or dispersion of the components (A) to (G) of the system described above and foaming the aqueous solution or dispersion by heating, i.e., with hot air or microwave.

The introduction of energy may preferably be effectuated via electromagnetic radiation, for example via high-frequency radiation at 5 to 400 kW, preferably 5 to 200 kW and more preferably 9 to 120 kW per kilogram of the mixture used in a frequency range from 0.2 to 100 GHz, preferably 0.5 to 10 GHz. Magnetrons are a useful source of dielectric radiation, and one magnetron can be used or two or more magnetrons at the same time.

The production of the polylysine foams is preferably carried out after the one-shot method, for example with the aid of the high pressure—or low-pressure technique. The foams can be discontinuously produced in open or closed molds or by continuous application of the reaction mixture to conveyor belts to produce foam blocks can be created.

It is particularly advantageous, according to the so-called two-component method to operate, in the case of, as stated above, a polylysine component and a reducing sugar component are prepared and foamed. The components are preferably in the range between 15 to 120° C. at a temperature, preferably 20 to 80° C. mixed and introduced into the mold or applied to the conveyor belt. The temperature in the mold is usually in the range between 15 and 120° C., preferably between 30 and 80° C.

A preferred process comprises the following steps:
(a) preparing an aqueous solution or suspension comprising components (A) to (F),
(b) transferring the aqueous solution or suspension obtained in step (a) into a mold, and
(c) foaming the aqueous solution or suspension by warming to a temperature in the range from 35 to 100° C. or by exposure to microwave.

Subject to the invention is also a foam obtainable by the process described above.

Preferably the foam has a density in the range from 10 to 250 kg/m³, determined according to DIN 53420. The preferred density depends on the application. The density can be adjusted by the amount of blowing agent (F). With higher density the Shore hardness and compression load can be increased. Lower densities are preferred for a foam with higher flexibility.

Compared with melamine-formaldehyde foams the foams according to the invention have a lower Shore hardness and higher flexibility at comparable density.

Preferably the foam has a Shore hardness 000 in the range from 20 to 100, determined according to ASTM D 2240.

Preferably the foam has a compression stress value (compression load deflection) in the range from 0.3 to 90 kPa according to DIN EN ISO 3386.

The foam according to the invention is water-based, solvent-free and free of formaldehyde and isocyanate, can be obtained from biobased raw materials, such as reducing sugars and can be produced over a wide density range. The foam shows a high flexibility as evidenced by a low Shore hardness, has good cleaning behavior, high water uptake, moderate thermal insulation properties and good acoustical absorption properties over a wide frequency range and low air flow resistance.

The open-cell content is preferably more than 95%, determined by light microscopy.

The foam according to the invention may be used in building & construction, i.e., for cushioning and furniture in leisure or office environments like seats, sofas, mattresses or transportation in train, aircraft and automotive in seats, headrests, armrests. Further applications are in packaging, i.e. packaging material to protect delivering good, cleaning applications, such as cleaning sponges, floor pads, hand pads, as filter medium or in acoustic applications in Building & Construction, such as sound absorber in room acoustics for offices, schools, restaurants, noise chambers, furniture, separation walls, acoustic elements in walls and ceilings as well as silencer in air conditioning or transportation applications, such as sound absorber in automotive, under the hood motor for noise reduction or indoor as headliner, sun visor, hat rack. Further applications include thermal insulation in industrial applications, such as pipe insulation or insulation of air conditioning devices or for wall and roof insulation in Building & Construction. Applications in agriculture include growing substrate and floral foams.

### EXAMPLES

Hereinafter, the present invention is described in more detail and specifically with reference to the Examples, which however are not intended to limit the present invention.

### Raw Materials Used:

Surfactant 1: Anionic surfactant Hostapur® SAS 93 (C14-C17 sec. alkyl sulfonate sodium salt), WeylChem
Surfactant 2: Non-ionic surfactant Lutensol® AT80 (C16-C18 fatty alcohol ethoxylate (˜80 units), BASF SE)
Surfactant 3 Surfactant mixture of Hostapur SAS93/Lutensol AT80 in a weight ratio of 6:4
Water: de-ionized water;
Polylysine-1: having a weight-average molecular weight Mw of about 1,200 g/mol (50 wt.-% in water);
Polylysine-2: having a weight-average molecular weight Mw of about 2,000 g/mol (50 wt.-% in water).
Polylysine-3: having a weight-average molecular weight Mw of about 3,000 g/mol (50 wt.-% in water);
Polylysine-4: having a weight-average molecular weight Mw of about 4,000 g/mol (50 wt.-% in water);
Polylysine-1 to 4 were prepared according to Example 1 of WO 2022/136612 by thermal treatment of L-lysine
Crosslinker: 1,3-dihydroxyacetone (80 wt.-% in aqueous solution).
Physical blowing agent: mixture n-pentane/iso-pentane 80/20 wt.-%
Salt: Na-formate, Na-acetate, Na-citrate, Na-chloride
MF Melamine-formaldehyde precondensate having an average molecular weight (number average) Mn of 350 g/mol, with a molar ratio of melamine:formaldehyde of 1:3

Determination of the weight-average molecular weight M_{w} of polylysine M_{w} was determined by size exclusion chromatography under the following conditions:
Solvent and eluent: 0.1% (w/w) trifluoroacetate, 0.1 M NaCl in distilled water
Flow: 0.8 ml/min
Injection volume: 100 μl
Samples are filtrated with a Sartorius Minisart RC 25 (0.2 μm) filter
Column material: hydroxylated polymethacrylate (TSKgel G3000PWXL)
Column size: inside diameter 7.8 mm, length 30 cm
Column temperature: 35° C.
Detector: DRI Agilent 1100 UV GAT-LCD 503 [232 nm]
Calibration with poly (2-vinylpyridine) standards in the molar mass range from 620 to 2890000 g/mole (from PSS, Mainz, Germany) and pyridine (79 g/mol).
The upper integration limit was set to 29.01 mL.
The calculation of M_{w} includes the lysine oligomers and polymers as well as the monomer lysine.

### Characterization of the Foams

The foam density is determined according to DIN 53420.

Shore hardness was measured according to ASTM D 2240. For the measurement of low density foams the scale of 000 was used (2.4 mm diameter of the sphere, spring force 1.111 N). Sample conditioning: 23° C., 50% rel. humidity, 24 h.

The air flow resistance was measured according to ASTM C-522.

Compression stress value (compression load deflection) CV 40 was measured according to DIN EN ISO 3386-1.

### Examples 1-45: Preparation of Pentane-Blown Polylysine Based Foams

The polylysine, the (di-)hydroxyacetone, the surfactants and optionally the salts are solved in water and the mixture is treated with a high-shear mixer at high velocity for 1 min. Next, the physical blowing agent, e. g. pentane, is added and stirred again for 10 s. Finally, the whole mixture is transferred to a heated mold or to a mold (e.g. paper box of 25×25×25 cm) that is exposed to hot air (oven) or microwave.

Procedure A: Microwave: 4×2.45 GHZ, 60 s; afterwards oven: 50° C., 24 h.

Procedure B: Oven: 80 and 100° C., 24 h.

After cooling, the new solid foam with fine and homogeneous cell structure is demolded.

Composition and mechanical properties of the foams obtained are shown in Tables 1-7.

Table 1 shows, that Shore hardness and compression load can be increased by using polylysine with a weight-average molecular weight in the range from 1,000 to 3,000 g/mol.

Table 5 and 6 show the influence of density on mechanical properties, such as Shore hardness and compression load.

TABLE 1
Variation of the molecular weight of
polylysine without salt, Procedure A

| Example | 1 | 2 | 3 | 4 |
|---|---|---|---|---|
| Polylysine-1, 1,200 g/mol, | 78 | — | — | — |
| 50% aqueous solution/g | | | | |
| Polylysine-2, 2,000 g/mol, | — | 78 | — | — |
| 50% aqueous solution/g | | | | |
| Polylysine-3, 3,000 g/mol, | — | — | 78 | — |
| 50% aqueous solution/g | | | | |
| Polylysine-4, 4,000 g/mol, | — | — | — | 78 |
| 50% aqueous solution/g | | | | |
| Tenside-Mixture: Hostapur | 3.6 | 3.6 | 3.6 | 3.6 |
| SAS93/Lutensol AT80 6:4/g | | | | |
| Dihydroxyacetone, 80% aqueous | 15.8 | 15.8 | 15.8 | 15.8 |
| solution/g | | | | |
| Blowing Agent Pentane/g | 8.0 | 8.0 | 8.0 | 8.0 |
| Density/kg/m3 | 16.4 | 18.1 | 20.3 | 19.5 |
| Shore hardness 000, after tempering | 42 | 60 | 69 | <30 |
| at 23° C./50% rel. humidity | | | | |
| Compression load/kPa, after | 1.0 | 3.3 | 17.5 | <0.3 |
| tempering at 23° C./80% rel. humidity | | | | |

TABLE 2
Variation of the salt in the formulation of the polylysine foam, Procedure A

| Example | 5 | 6 | 7 | 8 | 9 | 10 | 11 | 12 |
|---|---|---|---|---|---|---|---|---|
| Polylysine-2, 2,000 g/mol, | 117 | 117 | 117 | 117 | 117 | 117 | 117 | 117 |
| 50% aqueous solution/g | | | | | | | | |
| Tenside-Mixture: Hostapur | 5.4 | 5.4 | 5.4 | 5.4 | 5.4 | 5.4 | 5.4 | 5.4 |
| SAS93/Lutensol AT80 6:4/g | | | | | | | | |
| Dihydroxyacetone, 80% | 23.7 | 23.7 | 23.7 | 23.7 | 23.7 | 23.7 | 23.7 | 23.7 |
| aqueous solution/g | | | | | | | | |
| Salt: Na-formate/g | 1.5 | 1.75 | 2 | 2.25 | 2.5 | 2.75 | 3 | — |
| Salt: Na-chloride/g | — | — | — | — | — | — | — | 2 |
| Blowing Agent Pentane/g | 8 | 8 | 8 | 8 | 8 | 8 | 8 | 8 |
| Density kg/m3 @ 23° C., | 21.5 | 25.6 | 20.0 | 20.0 | 18.5 | 20.1 | 22.0 | 19.2 |
| 50% rel. humidity | | | | | | | | |
| Shore hardness 000, after | 68 | 62 | 64 | 55 | 52 | 56 | 71 | 38 |
| tempering at 23° C./50% rel. | | | | | | | | |
| humidity | | | | | | | | |
| Compression load/kPa, | 0.79 | 0.81 | 0.50 | 1.13 | 1.1 | 1.48 | 0.59 | 0.38 |
| after tempering at | | | | | | | | |
| 23° C./80% rel. humidity | | | | | | | | |
| Air Flow Resistance/ | — | — | — | 5400 | 6400 | 7200 | — | — |
| Pas/m² | | | | | | | | |

TABLE 3
Variation of the surfactant without salt, Procedure A

| Example | 13 | 14 | 15 | 16 | 17 | 18 | 19 | 20 | 21 | 22 |
|---|---|---|---|---|---|---|---|---|---|---|
| Polylysine-2, 2,000 g/mol, | 117 | 117 | 117 | 117 | 117 | 117 | 117 | 117 | 117 | 117 |
| 50% aqueous solution/g | | | | | | | | | | |
| Hostapur SAS93 | 3.2 | 3.8 | 4.3 | 4.9 | 5.4 | 6.5 | 7.6 | 8.6 | 9.7 | 10.8 |
| Dihydroxyacetone, 80% | 23.7 | 23.7 | 23.7 | 23.7 | 23.7 | 23.7 | 23.7 | 23.7 | 23.7 | 23.7 |
| aqueous solution/g | | | | | | | | | | |
| Salt: Na-formate/g | — | — | — | — | — | — | — | — | — | — |
| Blowing Agent Pentane/g | 8 | 8 | 8 | 8 | 8 | 8 | 8 | 8 | 8 | 8 |
| Density @ 23° C., 50% rel. | 20.4 | 18.0 | 17.8 | 16.9 | 16.4 | 17.8 | 18.1 | 16.7 | 18.0 | 20.2 |
| humidity/kg/m³ | | | | | | | | | | |
| Shore hardness, after | 68 | 62 | 56 | 53 | 63 | 61 | 65 | 58 | 61 | 61 |
| tempering at 23° C./50% | | | | | | | | | | |
| rel. humidity | | | | | | | | | | |
| Compression load/kPa, | 1.28 | 0.98 | 0.91 | 0.84 | 1.54 | 0.96 | 0.97 | 1.08 | 0.72 | 0.87 |
| after tempering at | | | | | | | | | | |
| 23° C./80% rel. humidity | | | | | | | | | | |

TABLE 4
Variation of the Surfactant with salt, Procedure A

| Example | 23 | 24 |
|---|---|---|
| Polylysine-2, 2,000 g/mol, 50% aqueous solution/g | 117 | 117 |
| Hostapur SAS93 | 5.4 | 6.5 |
| Dihydroxyacetone, 80% aqueous solution/g | 23.7 | 23.7 |
| Salt: Na-formate/g | 2 | 2 |
| Blowing Agent Pentane/g | 8 | 8 |
| Density @ 23° C., 50% rel. humidity/kg/m³ | 25.9 | 22.2 |
| Shore hardness 000, after tempering at | 47 | 49 |
| 23° C./50% rel. humidity | | |
| Compression load/kPa, after tempering at | 0.59 | 0.46 |
| 23° C./80% rel. humidity | | |

TABLE 5
Variation of the foam density without salt, Procedure A

| Example | 25 | 26 | 27 | 28 | 29 | 30 |
|---|---|---|---|---|---|---|
| Polylysine-2, 2,000 | 117 | 117 | 117 | 117 | 117 | 117 |
| g/mol, 50% aqueous | | | | | | |
| solution/g | | | | | | |
| Tenside-Mixture: | 5.4 | 5.4 | 5.4 | 5.4 | 5.4 | 5.4 |
| Hostapur SAS93/ | | | | | | |
| Lutensol AT80 6:4/g | | | | | | |
| Dihydroxyacetone, 80% | 23.7 | 23.7 | 23.7 | 23.7 | 23.7 | 23.7 |
| aqueous solution/g | | | | | | |
| Blowing Agent | 10 | 9 | 8 | 7 | 6 | 5 |
| Pentane/g | | | | | | |
| Density/kg/m³ @ 23° | 16.6 | 18.2 | 20.5 | 23.0 | 27.1 | 30.9 |
| C., 50% rel. humidity | | | | | | |
| Shore hardness 000, | 45 | 62 | 65 | 71 | 75 | 76 |
| after tempering at 23° | | | | | | |
| C./50% rel. humidity | | | | | | |
| Compression load/kPa, | 0.96 | 0.91 | 1.13 | 1.12 | 1.10 | 2.23 |
| after tempering at 23° | | | | | | |
| C./80% rel. humidity | | | | | | |

TABLE 6
Variation of the foam density with salt, Procedure A

| Example | 31 | 32 | 33 | 34 | 35 | 36 | 37 | 38 | 39 | 40 | 41 |
|---|---|---|---|---|---|---|---|---|---|---|---|
| Polylysine-2, 2,000 | 117 | 117 | 117 | 117 | 117 | 117 | 117 | 117 | 117 | 117 | 117 |
| g/mol, 50% aqueous | | | | | | | | | | | |
| solution/g | | | | | | | | | | | |
| Tenside-Mixture: | 5.4 | 5.4 | 5.4 | 5.4 | 5.4 | 5.4 | 5.4 | 5.4 | 5.4 | 5.4 | 5.4 |
| Hostapur SAS93/ | | | | | | | | | | | |
| Lutensol AT80 6:4/g | | | | | | | | | | | |
| Dihydroxy-acetone, | 23.7 | 23.7 | 23.7 | 23.7 | 23.7 | 23.7 | 23.7 | 23.7 | 23.7 | 23.7 | 23.7 |
| 80% aqueous solution/g | | | | | | | | | | | |
| Salt: Na-formate/g | 2 | 2 | 2 | 2 | 2 | 2 | 2 | 2 | 2 | 2 | 2 |
| Blowing Agent Pentane/g | 12 | 10 | 9 | 8 | 7 | 6 | 5 | 4 | 3 | 2 | 1 |
| Density/kg/m³ @ 23° C., | 10.0 | 16.4 | 17.0 | 20.5 | 22.5 | 23.3 | 32.5 | 42.0 | 55.2 | 71.2 | 95.6 |
| 50% rel. humidity | | | | | | | | | | | |
| Shore hardness 000, | 21 | 30 | 52 | 64 | 71 | 72 | 67 | 77 | 80 | 84 | 90 |
| after tempering at 23° | | | | | | | | | | | |
| C./50% rel. humidity | | | | | | | | | | | |
| Compression load/kPa, | 0.45 | 0.46 | 0.47 | 0.50 | 0.70 | 0.87 | 1.19 | 2.29 | 10.9 | 27.0 | 87.2 |
| after tempering at 23° | | | | | | | | | | | |
| C./80% rel. humidity | | | | | | | | | | | |

TABLE 7
Variation of the foaming procedure: Oven
foaming without microwave, Procedure B

| | Example | | | |
|---|---|---|---|---|
| | 42 | 43 | 44 | 45 |
| | Oven | Oven | Oven | Oven |
| | 80° C. | 80° C. | 100° C. | 100° C. |
| Polylysine-2, 2,000 g/mol, | 117 | 117 | 117 | 117 |
| 50% aqueous solution/g | | | | |
| Tenside-Mixture: Hostapur | 5.4 | 5.4 | 5.4 | 5.4 |
| SAS93/Lutensol AT80 6:4/g | | | | |
| Dihydroxyacetone, 80% | 23.7 | 23.7 | 23.7 | 23.7 |
| aqueous solution/g | | | | |
| Salt: Na-formate/g | — | 2.0 | — | 2.0 |
| Blowing Agent Pentane/g | 8.0 | 8.0 | 8.0 | 8.0 |
| Density/kg/m3 @ 23° C., | 24.4 | 25.9 | 18.0 | 25.9 |
| 50% rel. humidity | | | | |
| Shore hardness 000, after | 70 | 68 | 57 | 56 |
| tempering at 23° C./50% rel. | | | | |
| humidity | | | | |
| Compression load/kPa, after | 0.92 | 0.47 | 1.23 | 0.61 |
| tempering at 23° C./80% | | | | |
| rel. humidity | | | | |

### Comparative Exampled C1-C15

### Preparation of the Melamine Resin Foam

100 parts by weight of the melamine-formaldehyde precondensate, MF, 38 parts by weight of water, 1.2 parts by weight of anionic surfactant T1, 0.3 parts by weight of non-ionic surfactant T2, 2.5 parts of sodium formate, 3.0 parts of formic acid and 19.5 parts by weight of the pentane were mixed with one another at a temperature of 20 to 35° C. The mixture was introduced into a foaming mold of polypropylene and irradiated in a microwave oven with microwave. The foam bodies obtained after microwave irradiation were annealed in a circulating air oven at 200° C. for 20 min. Blowing agent content, density, and Shore hardness are summarized in Table 8.

TABLE 8
Comparison trials of flexible melamine foams:

| Comparative | Blowing agent | | Shore |
|---|---|---|---|
| Example | Pentane/g | Density/kg/m³ | hardness 000 |
| C1 | 6 | 45 | 112 |
| C2 | 7 | 42.5 | 99 |
| C3 | 8 | 40 | 99 |
| C4 | 9 | 37.5 | 93 |
| C5 | 10 | 35 | 88 |
| C6 | 11 | 32.5 | 86 |
| C7 | 12 | 30 | 84 |
| C8 | 13 | 27.5 | 83 |
| C9 | 14 | 25 | 81 |
| C10 | 16 | 22.5 | 75 |
| C11 | 17 | 20 | 68 |
| C12 | 18 | 17.5 | 67 |
| C13 | 22 | 15 | 63 |
| C14 | 30 | 12.5 | 52 |
| C15 | 40 | 10.0 | 48 |

1.-15. (canceled)

16. A process for producing a foam, which comprises foaming a mixture, comprising one or more poly (amino acid) (A), one or more components (B) capable of reacting with said poly (amino acid) (A) and one or more blowing agents (F), wherein component (B) is selected from reducing sugars, 1,3-dihydroxyacetone, glycolaldehyde, glyceraldehyde or any mixture thereof.

17. A process according to claim 16, wherein the mixture comprises
10 to 60 wt.-% of one or more poly (amino acid) (A);
3 to 30 wt.-% of one or more components (B) capable of reacting with said poly (amino acid) (A);
0.5 to 5 wt.-% of one or more salts of an inorganic acid or organic carboxylic acid (C);
3 to 10 wt.-% of one or more surfactants (D);
10 to 60 wt.-% of water (E);
1 to 20 wt.-% of one or more physical blowing agents (F); and
0 to 82.5 wt.-% of one or more additional additives (G);
wherein the sum of the weight percentages of said components A) to G) is 100 wt.-%.

18. The process according to claim 16, wherein the poly (amino acid) (A) is polylysine with a weight-average molecular weight M_{w} in the range from 800 to 20,000 g/mol, determined by size exclusion chromatography (SEC).

19. The process according to claim 16, wherein 1,3-dihyroxyacetone is used as component (B).

20. The process according to claim 16, wherein salts of an inorganic acid or organic carboxylic acid (C) is Na-formate, Na-acetate or Na-citrate.

21. The process according to claim 16, wherein the physical blowing agent (F) is a C4-C8-hydrocarbon.

22. The process according to claim 16, wherein a mixture of an anionic and a non-ionic surfactant is used as surfactant (D).

23. The process according to claim 16, wherein a flame retardant is used as additive (F).

24. The process according to claim 16, wherein the weight ratio of poly (amino acid) (A) to component (B) is in the range from 2:1 to 5:1.

25. The process according to claim 21, wherein the weight ratio of anionic surfactant to nonionic surfactant is in the range from 50:50 to 90:10.

26. The process according to claim 16, wherein the process comprises the following steps:
(a) preparing an aqueous solution or suspension comprising components (A) to (G),
(b) transferring the aqueous solution or suspension obtained in step (a) into a mold, and
(c) foaming the aqueous solution or suspension by warming to a temperature in the range from 35 to 100° C. or by exposure to microwave.

27. A foam obtained by the process according to claim 16.

28. The foam according to claim 27 having a density in the range from 10 to 250 kg/m³, determined according to DIN 53420.

29. The foam according to claim 27 having a shore hardness 000 in the range from 20 to 100, determined according to ASTM D 2240.

30. The foam according to claim 27 having a compression stress value in the range from 0.3 to 90 kPa according to DIN EN ISO 3386-1.
